(19) United States
(12) Patent Application Publication
(10) Pub. No.: US 2022/0224673 A1
(43) Pub. Date: Jul. 14, 2022

(54) SYSTEM AND METHOD FOR ISOLATING DATA FLOW BETWEEN A SECURED NETWORK AND AN UNSECURED NETWORK

(71) Applicant: Terafence Ltd., Haifa (IL)

(72) Inventors: Ilan Shimony, Haifa (IL); Ayal Avrech, Haifa (IL)

(73) Assignee: Terafence Ltd., Haifa (IL)

(21) Appl. No.: 17/147,472

(22) Filed: Jan. 13, 2021

(51) Int. Cl. H04L 29/06

(52) U.S. Cl. CPC H04L 63/0236; H04L 63/0245; H04L 63/20

(57) ABSTRACT

Methods and systems for isolating data flow between a secured network and an unsecured network may include a configurable flow control module, communicatively connected to the secured network and to the unsecured network; and a state selector module, associated with the flow control module and adapted to dynamically configure a state of the flow control module. The flow control module may include at least one hardware switch, configured to isolate between the secured network and the unsecured network, by allowing unidirectional transfer of data from the secured network to the unsecured network via a communication channel, based on the configured state.

### FIELD OF THE INVENTION

The present invention relates generally to computer networks. More specifically, the present invention relates to systems and methods for securing computer domains and network connectivity.

### BACKGROUND OF THE INVENTION

Currently available systems for securing computer domains and network connectivity may employ electronic devices such as “data diodes” to implement unidirectional data transfer. Such devices may use “air gap” technology to isolate between a transmitting side and a receiving side. For example, data diode solutions for fiber-optic computer data communication may employ opto-coupling devices to transmit data in one direction from a transmitter to a receiver and not employ opto-coupling devices from the receiver to the transmitter. Hence, such systems may isolate data transfer between the receiver and the transmitter, and thus achieve unidirectional data transfer. Such air gap technology for isolation of a transmitter from a receiver is implemented on the first layer of the standard Open Systems Interconnection (OSI) communication model, also known in the art as the Physical (PHY) layer. For example, in fiber-optic communication, isolation between the transmitter and receiver may be done by disallowing the carrier of data (e.g., the modulated transmitted light) to pass from the receiver side to the transmitter side.

### SUMMARY OF THE INVENTION

It may be appreciated by a person skilled in the art that such implementations describe above include various disadvantages. For example, the directionality of air-gap based solutions is fixed, cannot be easily or dynamically configured or changed. In another example, up-scaling of air-gap solutions for network isolation may require the addition of PHY-level components, and may contradict design and cost constraints. In yet another example, system and methods that isolate between networks based on the PHY level may be limited to a specific PHY media (e.g., fiberoptics, coaxial cable, twisted-pair cables, etc.) and may not be utilized to provide networking security solutions for communication networks that employ other types of PHY media.

A system and method for isolating a secured network from an unsecured network, that may be dynamically, and easily configurable, scalable, and not limited to any specific PHY media is therefore desired.

Embodiments of the invention may include a system for isolating data flow between a secured network and an unsecured network. Embodiments of the system may include, for example, a configurable flow control module, communicatively connected to the secured network and to the unsecured network; and a state selector module, associated with the flow control module. The state selector module may be adapted to dynamically configure a state of the flow control module, as elaborated herein.

According to some embodiments of the invention, the flow control module may include at least one hardware switch, configured to isolate the secured network from the unsecured network, by allowing unidirectional transfer of data from the secured network to the unsecured network (e.g., disabling transfer of data from the unsecured network to the secured network) via a first communication channel, based on the configured state.

According to some embodiments of the invention, the flow control module may not include, or be devoid of, a processing unit (e.g., a processor, a CPU, a GPU, and the like). Additionally, the flow control module may be not associated with, or not have an Internet protocol (IP) address. Additionally, the flow control module may not be associated, e.g., may not have a media access control (MAC) address.

According to some embodiments of the invention, the at least one hardware switch may be implemented by one or more transistors on an electronic device, such as a programmable array logic (PAL) device, a simple programmable logic device (SPLD), a complex programmable logic device (CPLD), a field programmable gate array (FPGA) device, and an application specific integrated circuit (ASIC) device.

According to some embodiments, the state of the flow control module may include, a unidirectional, secure-to-unsecure (S2U) state, a unidirectional, unsecure-to-secure (U2S) state, a bidirectional state and a disconnected state.

In the S2U state, the flow control module may be configured to allow unidirectional transfer of data from the secured network to the unsecured network via the first communication channel, and disallow transfer of data from the unsecured network to the secured network.

Additionally, in the U2S state, the flow control module may be configured to allow unidirectional transfer of data from the unsecured network to the secured network via the first communication channel, and disallow transfer of data from the secured network to the unsecured network. According to some embodiments, the flow control module may be configured to be in the U2S state for a configurable period of time, and/or until a predefined event occurs, after which the flow control module may be configured to switch to the S2U state.

Additionally, in the bidirectional state, the flow control module may be configured to allow transfer of data from the secured network to the unsecured network via the first communication channel, and allow transfer of data from the unsecured network to the secured network via the first communication channel. The flow control module may be configured to be in the bidirectional state for a configurable period of time or until a predefined event occurs, after which the flow control module may be configured to switch to the S2U state.

Additionally, in the disconnected state, the flow control module may be configured to disallow transfer of data from the secured network to the unsecured network via the first communication channel, and disallow transfer of data from the unsecured network to the secured network via the first communication channel.

Embodiments of the invention may include a first protocol termination module and a second protocol termination module. In the S2U state and/or in the bidirectional state, the first protocol termination module may be adapted to: receive at least one connection-oriented data element from at least one first computing device of the secured network; transmit an acknowledgement data element, corresponding to the at least one connection-oriented data element to the at least one first computing device; and transmit the at least one connection-oriented data element, via the second protocol termination module, to at least one second computing device of the unsecured network. In the U2S state and/or in the bidirectional state, the second protocol termination module may be adapted to: receive at least one connection-oriented data element from at least one first computing device of the unsecured network; transmit a response data element, corresponding to the at least one connection-oriented data element, to the at least one first computing device; and transmit the at least one connection-oriented data element, via the first protocol termination module, to at least one second computing device of the secured network.

Embodiments of the invention may include a filter module, adapted to: receive one or more secondary channel data elements from at least one of: (a) the second protocol termination module and (b) a computing device in the unsecured network; and filter the one or more secondary channel data elements, so as to transfer a subset of the one or more received secondary channel data elements, to a computing device in the secured network, via a second communication channel.

According to some embodiments of the invention, the filter module may be further adapted to: receive a rule-base data structure; and filter the one or more secondary channel data elements according to the rule-base data structure.

According to some embodiments of the invention, the filter module may be communicatively connected to a trusted computing device in the secured network 20, and may be adapted to adapted to: dynamically receive, from the trusted computing device, a configuration signal or message; and configure the rule-base data structure according to the received configuration message.

According to some embodiments of the invention, filtering the one or more secondary channel data elements may include allowing only a subset of the received secondary channel data elements to pass to the secured network, via the second communication channel.

According to some embodiments of the invention, at least one received secondary channel data element may include payload data in a first version. In such embodiments, filtering the secondary channel data element may include changing the payload data to a second version; and transferring the secondary channel data element, with the payload data of the second version to the secured network, via the second communication channel.

the received one or more secondary channel data elements may originate from the second protocol termination module. The received one or more secondary channel data elements may include, for example, synchronization data, keep-alive packets and acknowledgment messages.

Additionally, or alternatively, the received one or more secondary channel data elements may originate from at least one first computing device in the unsecured network. The received one or more secondary channel data elements may include a command for operating at least one second computing device in the secured network.

According to some embodiments, the rule-base data structure may include at least one definition of a parameter and zero, one or more conditions corresponding to the parameter. The filter module may be adapted to filter the one or more secondary channel data elements according to the at least one defined parameter and corresponding zero or more conditions, as elaborated herein.

According to some embodiments, the one or more conditions may be arithmetic conditions, and the filter module may be adapted to filter the one or more secondary channel data elements according to the one or more arithmetic conditions.

Additionally, or alternatively, the one or more conditions may be logical conditions, and the filter module may be adapted to filter the one or more secondary channel data elements according to the one or more logical conditions.

Additionally, or alternatively, the rule-base data structure may include at least one definition of a parameter field, and zero, one or more conditions corresponding to the at least one parameter field. The filter module may be adapted to filter the one or more secondary channel data elements according to the at least one defined parameter field and corresponding zero or more conditions.

Additionally, or alternatively, the rule-base data structure may include at least one definition of a time frame and a corresponding definition of a number of occurrences. Additionally, or alternatively, the rule-base data structure may include more than one concurrent time frames. The filter module may be adapted to filter the one or more secondary channel data elements such that the number of transferred secondary channel data elements does not surpass the defined number of occurrences within the defined time frame.

According to some embodiments, the second communication channel may have a smaller transmission bandwidth in relation to a transmission bandwidth of the first communication channel.

According to some embodiments, the state selector module may be adapted to dynamically configure the state of the flow control module by: receiving a control signal from a trusted computing device of the secured network; and configuring the state of the flow control module according to the received control signal.

Embodiments of the invention may include a method of isolating data flow between a secured network and an unsecured network. Embodiments of the method may include: communicatively connecting a configurable flow control module, to the secured network and to the unsecured network; and using a state selector module, associated with the flow control module, to dynamically configure a state of the flow control module. The flow control module may include at least one hardware switch configured to isolate the secured network from the unsecured network by allowing unidirectional transfer of data from the secured network to the unsecured network (e.g., disabling transfer of data from the unsecured network to secured network) via a first communication channel, based on the configured state.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a system for isolating data flow between an unsecured network and a secured network, in a first configuration, according to some embodiments of the invention;

FIG. 2 is a block diagram, depicting the system for isolating data flow between a secured network and an unsecured network, in another configuration, according to some embodiments of the invention;

FIG. 3 is a block diagram, depicting the system for isolating data flow between a secured network and an unsecured network, in yet another configuration, according to some embodiments of the invention;

FIG. 4 is a schematic diagram, depicting a secondary communication channel rule data structure, that may be included in the system for isolating data flow between a secured network and an unsecured network, according to some embodiments of the invention; and

FIG. 5 is a flow diagram, depicting a method of securing network connectivity, e.g., by isolating data flow between a secured network and an unsecured network, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

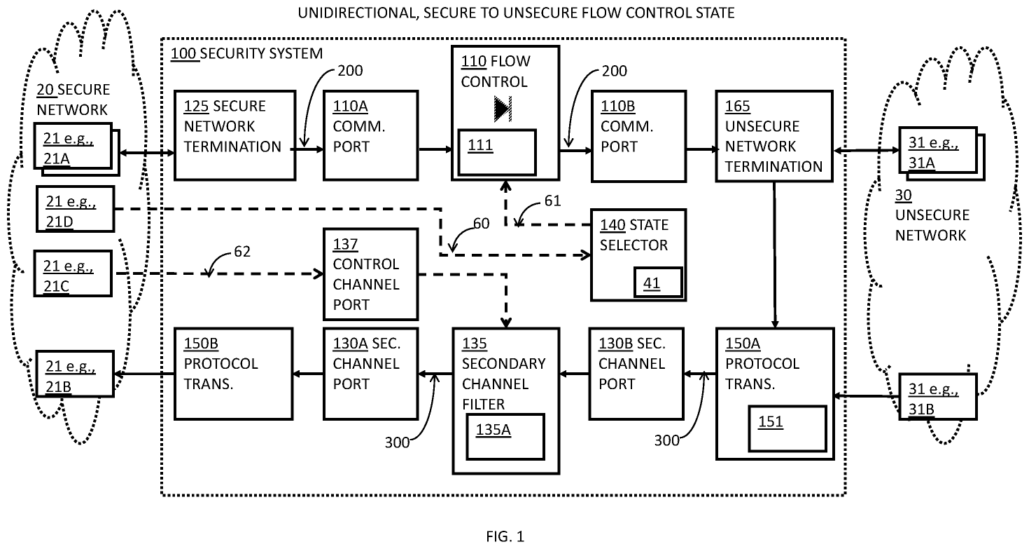

Reference is now made to FIG. 1 which is a block diagram, depicting a system 100 for isolating a secured network 20 from one or more unsecured networks 30. The term “isolation” may be used in this context to indicate that access of elements (e.g., computing devices 31) in unsecured network 30 to assets or elements of secured network 20 (e.g., computing devices 21 and/or data stored on, or conveyed by computing devices 21) may be physically restricted, as elaborated herein.

As shown in FIG. 1, secured network 20 may be isolated from unsecured network 30 in a first configuration, where data flow from unsecured network 30 to secured network 20 is physically (e.g., not by means of software) restricted or disabled, according to some embodiments of the invention.

As shown in FIG. 1, secured network 20 may include one or more computing devices 21 (e.g., 21A, 21B, 21C), and unsecured network 30 may include one or more computing devices 31 (e.g., 31A, 31B). Computing devices 21 and 31 may, for example, be desktop computers, laptop computers, smartphone devices, server computers, data storage devices, Internet of Things (IoT) devices, embedded computers and the like.

The term “secured” may be used herein to indicate a condition in which access to data and/or computing resources such as computing devices 21 of secured network 20 may be limited, by system 100, for elements beyond secured network 20.

For example, secured network 20 may be an organizational network, and unsecured network 30 may be a computer network such as the Internet, and may include one or more computers beyond the organizational secured network 20. In this example, system 100 may be configured, to limit access (e.g., read access, write access, etc.) of the one or more computing devices 31 of unsecured network 30 to computing devices 21 of secured network 20, in a dynamic, and physical manner, as elaborated herein. The term “physically” may be used in this context in a sense that isolation of secured network 20 from unsecured network may be hardware-based, e.g., based on electronic switches or transistors, as elaborated herein, and may not be susceptible to software-based hacking or tampering. The term “dynamic” may be used in this context in a sense that the configuration of system 100 and the allowance of data flow between network 20 and network 30 based on real-world events. Such real-world events may include, for example, elapse of a time limit, or a command or indication received from an administrative user and/or computing device.

An unsecured network may allow free or unfettered access to its components, or relatively free and unfettered access relative to a secured network.

For example, system 100 may dynamically allow or disallow unidirectional flow (e.g. in only one of two or more directions) of data from network 20 to network 30, dynamically allow or disallow unidirectional flow of data from network 30 to network 20, dynamically allow or disallow bidirectional flow of data between network 30 and network 20, and dynamically disallow flow of data from network 30 and network 20 and from network 20 to network 30.

As shown in FIG. 1, system 100 may include a configurable flow control module 110, communicatively connected to secured network 20 (e.g., to at least one computing device 21) and to unsecured network 30 (e.g., to at least one computing device 31).

According to some embodiments of the invention, flow control module 110 may be devoid of, e.g., not include, a processing unit (e.g., a controller, a processor, a central processing unit (CPU), a graphical processing unit (GPU), and the like) for processing software. Additionally, flow control module 110 may not include or be associated with an address that may allow remote access thereto. For example, flow control module 110 may not have or be associated with an Internet protocol (IP) address and/or a media access control (MAC) address, and may not include a processor or controller that may receive an access request (e.g., a read request, a write request, etc.) from a computing device from beyond system 100.

According to some embodiments of the invention, flow control module 110 may include one or more hardware switches 111. The term “hardware” may be used herein to indicate that the one or more hardware switches 111 may be devoid of elements for processing software code (e.g., a processor, a controller, a CPU, a GPU, and the like), and may be completely implemented by electronic hardware components such as electronic transistors. For example, the one or more hardware switches 111 may be implemented by one or more respective transistors in an electronic device that may be adapted to implement hardware logic, such as a programmable array logic (PAL) device, a simple programmable logic device (SPLD), a complex programmable logic device (CPLD), a field programmable gate array (FPGA) device, an application-specific integrated circuit (ASIC) device, and the like.

It may be appreciated by a person skilled in the art that hardware switch 111 (e.g., transistor) may provide an improvement in technology in relation to currently available data security systems such as data-diodes, that are based on air-gap technologies such as opto-couplers. Embodiments of the invention may facilitate simple upscaling, for example by adding additional hardware logic into a programmable device (e.g., FPGA) that may implement flow control module 110. Thus, in contrast to currently available data security systems based on air-gap technologies, embodiments of the invention may not require adding additional hardware to upscale the design.

System 100 may further include a state selector module 140, associated with, or connected to flow control module 110. As elaborated herein, state selector module 140 may be adapted to dynamically configure a state of flow control module 110, e.g., by sending a control signal to the one or more hardware switches 111 (e.g., transistors) of flow control module 110.

According to some embodiments, state selector module 140 may be completely disconnected from the primary communication channel 200, and may also be devoid of a communication address (e.g., a MAC address, an IP address, etc.) and/or a processing unit (e.g., a processor, a controller, etc.). Thus, state selector module 140 may set the state of flow control module 110 (e.g., the direction of data flow) in a secure manner, in a sense that it may not be tampered by a user of a computing device (e.g., 31 and/or 21) via primary communication channel 200 (e.g., Ethernet).

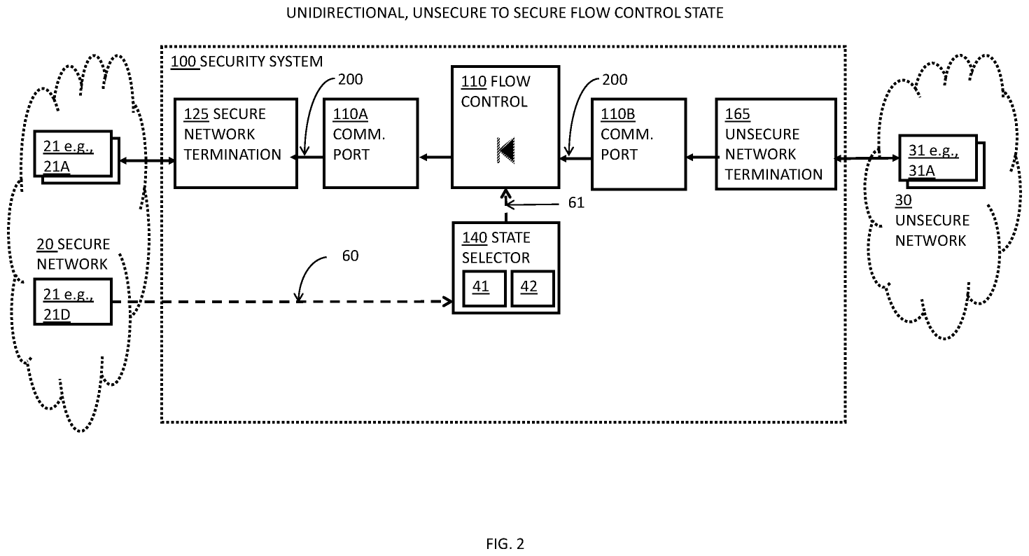

For example, state selector module 140 may be associated with, and/or controlled by a hardware component such as a selector, or push button 41, as elaborated herein (e.g., in relation to FIG. 2). Additionally, or alternatively, state selector module 140 may be communicatively connected, via a dedicated connection 61, other than primary channel 200, to a computing device 21 of secured network 20, as elaborated herein (e.g., in relation to FIG. 2).

It may be appreciated by a person skilled in the art that hardware switch 111 (e.g., transistor) may provide an additional improvement in technology in relation to currently available data security systems such as data-diodes, that are based on air-gap technologies such as lasers, or opto-couplers. Embodiments of the invention may facilitate simple configuration of the hardware switches 111 (e.g., transistors) by receiving an electronic control signal from selector module 140, to allow, disallow or change a direction of data transfer between secured network 20 and unsecured network 30, or the reverse direction, without requiring additional hardware to support dynamically configurable transfer of data from secured network 20 and unsecured network 30 and vice-versa.

According to some embodiments, selector module 140 may dynamically configure flow control module 110, to isolate secured network 20 from unsecured network 30 and/or allow transfer of data between secured network 20 and unsecured network 30, based on the configured state. In some embodiments, selector module 140 may dynamically configure flow control module 110 by configuring the one or more hardware switches 111 (e.g., transistors) of flow control module 110, so as to allow transfer of data signals between flow control module 110 based on the configured state.

For example, and as depicted in the example configuration of FIG. 1, selector module 140 may dynamically configure flow control module 110 to allow unidirectional transfer of data, from secured network 20 to unsecured network 30 based on the configured state, via a first communication channel or link 200, such as an Ethernet channel, a Transmission Control Protocol over Internet Protocol (TCP/IP) channel, a Hypertext Transfer Protocol (HTTP) channel, a Hypertext Transfer Protocol Secure (HTTPS) channel, and the like. The first communication channel or link 200 may herein be referred to as “primary channel” or “primary communication channel” 200.

Selector module 140 may do so, for example, by configuring the one or more hardware switches 111 (e.g., transistors) of flow control module 110 to allow transfer of data from secured network 20 to unsecured network 30 via primary channel 200, and disallow or prevent transfer of data from unsecured network 30 to secured network 20 via primary channel 200.

As elaborated herein (e.g., in the background section), currently available systems and methods for securing network connectivity typically achieve isolation between a transmitting side and a receiving side by disallowing transfer of PHY level signals (e.g., light signals, in the case of fiber-optic communication) from the receiver to the transmitter.

As depicted in FIG. 1, flow control module 110 may be connected to secured network 20 via a first communication port 110A and connected to unsecured network 30 via a second communication port 110B. According to some embodiments of the invention, first communication port 110A and second communication port 110B may interface with secured network 20 and unsecured network 30 respectively, using the first layer of the standard OSI communication model, also known in the art as the PHY layer.

According to some embodiments of the invention, first communication port 110A and second communication port 110B may interface flow control module 110 in a “promiscuous mode” as known in the art. The term “promiscuous” may be used in this context to indicate transferal of data regardless of MAC address. Flow control module 110 may thus be configured to allow or disallow transfer of data packets, regardless of their MAC address, between secured network 20 and unsecured network 30, according to the configuration by selector module 140. In other words, selector module 140 may configure the one or more hardware switches 111 of flow control module 110 to allow or disallow transfer of data packets, including MAC information, between secured network 20 and unsecured network 30.

It may be appreciated by a person skilled in the art that by controlling transfer of data secured network 20 and unsecured network 30 in the MAC layer level, embodiments of the invention may provide an improvement in technology in relation to currently available data security technology. Embodiments of the invention may not be limited to any specific PHY media. This is in contrast, for example, to currently available data security systems such as data-diodes, that are based on air-gap technologies such as opto-couplers, and are limited specific PHY level media types (e.g., fiber-optic communication cables).

According to some embodiments of the invention, selector module 140 may be adapted to dynamically select a state of flow control module 110. For example, selector module 140 may receive, e.g., from a trusted computing device 21 (e.g., 21D) of secured network 20, a first configuration signal 60. First configuration signal 60 may, for example, indicate a required state of flow control module 110, as one of a unidirectional, secure-to-unsecure state, a unidirectional, unsecure-to-secure state, a bidirectional state and a disconnected state. Selector module 140 may subsequently send a second configuration signal 61 to flow control module 110, to dynamically set the flow control state, based on the first configuration signal 60, e.g., to the unidirectional, secure-to-unsecure state, the unidirectional, unsecure-to-secure state, the bidirectional state and disconnected state.

The term “dynamically” may be used in this context to indicate that selector module 140 may receive the first configuration signal 60 at any time, e.g., asynchronous to primary communication channel 200. For example, selector module 140 may receive the first configuration signal 60 from a user of trusted computing device 21D, according to the user's discretion.

For example, selector module 140 may include or may be associated with a push button 41 or other physical switch, and may receive control signal 60 from push button 41 upon pressing or releasing of button 41 by a user. In another example, selector module 140 may be communicatively connected, e.g., via wired connection to a trusted computing device 21D in secured network 20, and may receive control signal 60 from trusted computing device 21D. In yet another example, selector module 140 may receive control signal 60 from an internal timer mechanism.

According to some embodiments, selector module 140 may send control signal 61 to flow control module 110, so as to configure flow control module 110 to operate according to the selected state of signal 60. The selected flow control state may be, for example, a unidirectional, secure-to-unsecure (S2U) state, as depicted in FIG. 1.

In the S2U state, flow control module 110 may be configured to allow unidirectional transfer of data from, or originating from secured network 20 to unsecured network 30 via primary communication channel 200 (e.g., Ethernet) or link. In the S2U state, flow control module 110 may also disallow, or prevent transfer of data from unsecured network 30 to secured network 20 via primary channel 200.

Reference is now made to FIG. 2 which is a block diagram, depicting system 100 for isolating data flow between secured network 20 and an unsecured network 30 in another configuration, according to some embodiments of the invention.

As shown in FIG. 2, secured network 20 may be isolated from unsecured network 30 in this configuration, in a sense that data flow from unsecured network 30 to secured network 20 is physically restricted or disabled, according to some embodiments of the invention.

Components of system 100 which are shown in FIG. 1 have been omitted from FIG. 2 for the purpose of clarity.

As depicted in FIG. 2, selector module 140 may be adapted to dynamically select a flow control state that is a unidirectional, unsecure-to-secure (U2S) state. Selector module 140 may send control signal 61 to flow control module 110, so as to configure flow control module 110 to operate according to the selected U2S state: in the U2S state, flow control module 110 may be configured to allow unidirectional transfer of data from, or originating from unsecured network 30 to secured network 20 via primary communication channel 200. Additionally, in the U2S state, flow control module 110 may be configured to disallow or prevent transfer of data from secured network 20 to unsecured network 30 via primary communication channel 200.

According to some embodiments, flow control module 110 may be adapted to be in the U2S state for a configurable, or predetermined period of time, and/or until an occurrence of a predefined event, such as a push or release of button 41 (or opening if it is a switch), or reception of a control signal. For example, selector module 140 may send a first control signal 61 to flow control module 110, so as to configure flow control module 110 to operate according to the selected U2S state, and subsequently, after a predefined period of time, send a second control signal 61 to flow control module 110, so as to configure flow control module 110 to operate according to the S2U state. Additionally, or alternatively, the period of the U2S state may be event driven. For example, selector module 140 may be adapted to send the first control signal 61 to flow control module 110 (to configure flow control module 110 to operate in the U2S state) when button 41 is pushed (e.g., by a user), and send the second control signal 61 (to configure flow control module 110 to operate according to the S2U state) when button 41 is released. Other configuration options are also available.

According to some embodiments, state selector 140 may include an indicator 42, such as one or more light emitting diodes (LEDs) a liquid display device (LCD) indicator and the like, that may indicate a configuration or state of flow control module 110 (e.g., S2U, U2S, bidirectional, and disconnected states) and/or a time remaining for flow control module 110 in that state.

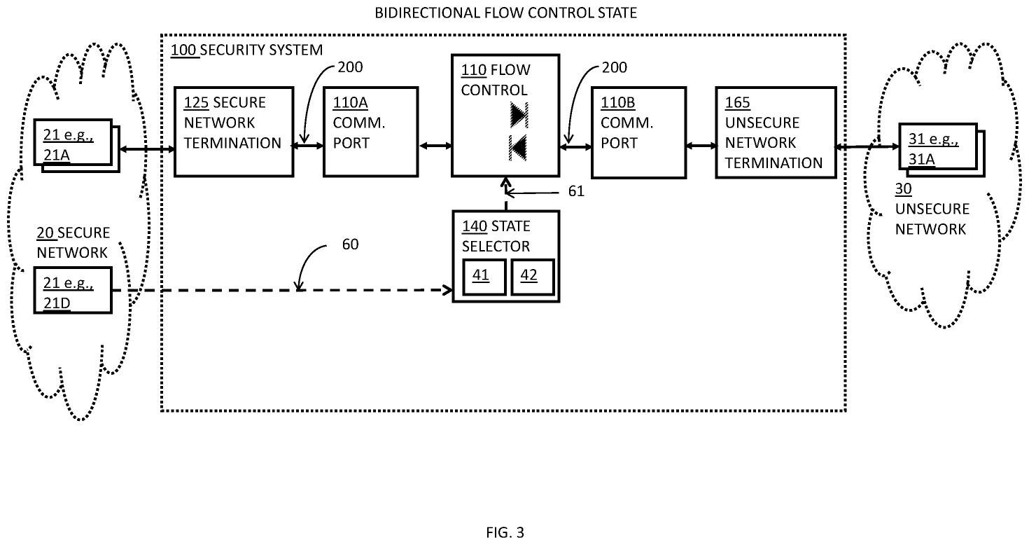

Reference is now made to FIG. 3 which is a block diagram, depicting a system 100 for isolating data flow between secured network 20 and an unsecured network 30 in another configuration, according to some embodiments of the invention. Components of system 100 of FIG. 1 have been omitted from FIG. 3 for the purpose of clarity.

As depicted in FIG. 3, selector module 140 may be adapted to dynamically select a flow control state that is a bidirectional state. Selector module 140 may send control signal 61 to flow control module 110, so as to configure flow control module 110 to operate according to the selected bidirectional state: In the U2S state, flow control module 110 may be configured to allow transfer of data from, or originating from unsecured network 30 to secured network 20 via primary communication channel 200. Additionally, in the bidirectional state, flow control module 110 may be configured to allow transfer of data from secured network 20 to unsecured network 30 via primary communication channel 200.

According to some embodiments, flow control module 110 may be configured to be in the bidirectional state for a configurable or predetermined period of time, and/or until an occurrence of a predefined event, such as a push or release of button 41 or reception of a control signal. For example, selector module 140 may send a first control signal 61 to flow control module 110, so as to configure flow control module 110 to operate according to the selected bidirectional state, and subsequently, after a predefined period of time, send a second control signal 61 to flow control module 110, so as to configure flow control module 110 to operate according to the S2U state. Additionally, or alternatively, the period of the bidirectional state may be event driven. For example, selector module 140 may be adapted to send the first control signal 61 to flow control module 110 (to configure flow control module 110 to operate in the bidirectional state) when button 41 is pushed (e.g., by a user), and send the second control signal 61 (to configure flow control module 110 to operate according to the S2U state) when button 41 is released. Other configuration options are also available.

According to some embodiments, selector module 140 may be adapted to dynamically select a flow control state that is a disconnected state. Selector module 140 may send control signal 61 to flow control module 110, so as to configure flow control module 110 to operate according to the selected disconnected state: In the disconnected state, the flow control module may be configured to disable transfer of data from, or originating from secured network 20 to unsecured network 30, via primary communication channel 200, and disallow transfer of data from unsecured network 30 to secured network 20 via primary communication channel 200.

Reference is now made back to FIG. 1, depicting system 100 according to some embodiments of the invention. As shown in FIG. 1, system 100 may interface secure network 20 via a first protocol termination module, denoted “secured network termination” module 125. Additionally, system 100 may interface unsecure network 30 via a second protocol termination module, denoted “unsecured network termination” module 165.

As known in the art, connection-oriented communication is a type of communication protocol that includes validation of reception of data packets, in the correct order, on the receiving side. Such validation requires the receiving side to send acknowledgement messages to the transmitting side. An example for a connection-oriented communication protocol is the Transmission Control Protocol (TCP). In contrast to connection-oriented communication, protocols that do not require validation of reception of data packets, in the correct order are referred to as connectionless communication protocols. An example for a connectionless communication protocol is the User Datagram Protocol (UDP).

According to some embodiments, secured network termination module 125 and unsecured network termination module 165 may be configured to terminate, as commonly referred to in the art, or act as termination points to connection-oriented communication protocols in conditions of unidirectional data transfer over primary channel 200. The term “terminate” may be used in this context to indicate that a connection-oriented protocol (e.g., TCP) data packet may be received by termination modules 125 and 165, and may be transferred to the relevant destination computing device, without receiving acknowledgement from that destination computing device.

For example, as elaborated herein, flow control module 110 may be configured to work in the unidirectional, S2U flow control state. In this condition, secured network termination module 125 may be configured to receive at least one connection-oriented data element (e.g., a TCP packet) from at least one first computing device 21 of secured network 20. Secured network termination module 125 may transmit an acknowledgement data element (e.g., an acknowledgement packet), corresponding to the at least one connection-oriented data element (e.g., the received TCP packet), to the at least one first computing device 21. Secured network termination module 125 may transmit the at least one connection-oriented data element (e.g., the received TCP packet), via flow control module 110 and primary channel 200 to at least one second computing device 31 of unsecured network 30. Secured network termination module 125 may thus be said to terminate the connection-oriented communication protocol (e.g., TCP) of secured network 20, as it enables connection-oriented communication (e.g., TCP) over primary communication channel 200 in a unidirectional flow control state.

In a similar manner, unsecured network termination module 165 may act as a termination point for a connection-oriented communication protocol (e.g., TCP) of unsecured network 30: For example, as elaborated herein, flow control module 110 may be configured to work in the unidirectional, U2S flow control state. In this condition, unsecured network termination module 165 may be configured to receive at least one connection-oriented data element (e.g., a TCP packet) from at least one first computing device 31 of unsecured network 30. Unsecured network termination module 165 may transmit a response data element, corresponding to the at least one connection-oriented data element (e.g., the received TCP packet), to the at least one first computing device 31. The response data element, may be, or may include, for example, an acknowledgement data element (e.g., an acknowledgement packet), a retransmission data element (e.g., requiring computing device 31 to retransmit a data packet), and the like. Unsecured network termination module 125 may further transmit the at least one connection-oriented data element (e.g., the received TCP packet), via flow control module 110 and primary channel 200 to at least one second computing device 21 of secured network 20. Unsecured network termination module 165 may thus be said to terminate the connection-oriented communication protocol (e.g., TCP) of unsecured network 30, as it enables connection-oriented communication (e.g., TCP) over primary communication channel 200 in a unidirectional flow control state.

Additionally, or alternatively, secured network termination module 125 and unsecured network termination module 165 may be configured to terminate connectionless protocol communications such as UDP communications.

For example, as known in the art, the UDP protocol includes a setup phase which requires full handshake process. Only after this handshake process is completed, unacknowledged packets may be sent via the UDP protocol. Secured network termination module 125 and unsecured network termination module 165 may terminate the UDP protocol by providing acknowledgement messages to computing devices (e.g., devices 21 and 31) participating in UDP communication. In another example, the resource reservation protocol (RSVP) may use UDP for data (e.g., video) transmission, but also requires an initial handshake. Secured network termination module 125 and unsecured network termination module 165 may terminate the RSVP protocol so as to establish RSVP communication between computing devices (e.g., devices 21 and 31).

As shown in FIG. 1, system 100 may support or include a second communication channel 300, different from, and in addition to, primary channel 200. Channel 300 may herein be referred to as “secondary channel” or “secondary communication channel” 300.

Secondary communication channel 300 may be adapted to transfer unidirectional data from unsecure network 30 and/or from unsecured network termination module 165 to at least one computing device 21 of secured network 20.

According to some embodiments of the invention, system 100 may include a filter module, denoted in FIG. 1 as secondary channel filter module 135.

According to some embodiments, secondary channel filter module 135 may be adapted to receive one or more secondary channel data elements 151 from at least one of: (a) unsecured network termination module 165 and (b) a computing device 31 in unsecured network 30. The one or more secondary channel data elements 151 may include, for example, data frames, data packets, data segments and the like, and may be addressed or targeted to one or more computing devices 21 of secured network 20.

Secondary channel filter module 135 may filter the one or more received secondary channel data elements 151, so as to transfer or transmit or transfer a subset or portion thereof (e.g. remove some elements from a data stream), to the addressed one or more computing device 21, as elaborated herein. In other words, secondary channel filter module 135 may transmit zero, one or more data elements, of the one or more received secondary channel data elements 151, to the addressed one or more computing device 21 in secured network 20, via secondary communication channel 300.

According to some embodiments, the received one or more secondary channel data elements 151 may originate from unsecured network termination module 165, and may include, for example: synchronization data, keep-alive packets, acknowledgment messages, control messages, command messages, configuration messages and the like.

For example, in the S2U unidirectional mode, a computing device 21 of secured network 20 may communicate data may via primary channel 200 to one or more computing devices 31 in unsecured network 30. As primary channel 200 is unidirectional, data pertaining to this communication, such as acknowledgement messages originating from the one or more computing devices 31 may not be transferred via primary channel 200 back to computing device 21. Instead, unsecured network termination module 165 may communicate with computing devices 31, and may transfer the acknowledgement messages back to computing device 21 of secured network 20, as a secondary channel data element 151, via secondary channel 300.

Secondary channel filter module 135 may be adapted to analyze the secondary channel data element 151 (e.g., the acknowledgement messages), to transfer only safe acknowledgement messages back to the target computing device 21 of secured network 20, according to a rule-base data structure 135A, as elaborated herein. For example, filter module 135 may be configured to only allow a predefined number of secondary channel data element 151 to be transferred via secondary channel 300 in a given period of time. Additionally, or alternatively, filter module 135 may be configured to only allow transfer of secondary channel data element 151 that are acknowledgement messages, if these acknowledgement messages pertain to specific, previous communication of data, from computing device 21 to computing devices 31.

It may be appreciated by a person skilled in the art, that by transferring acknowledgement messages as secondary channel data elements 151, according to rules of rule-base data structure 135A, secondary channel may complement the unidirectional communication of primary channel 200, and facilitate connection-oriented and/or connectionless communication in a secure, and monitored manner.

In another example, processes that are executed on computing device 21 in one or more secured networks 20 may need to be synchronized with processes that are executed on one or more computing devices 31 in unsecured network 30. Unsecured network termination module 165 may be configured to send one or more secondary channel data elements 151, that include synchronization messages, or “keep alive” messages, to facilitate the required synchronization. Secondary channel filter module 135 may be adapted to analyze the secondary channel data element 151 (e.g., the synchronization messages, keep alive messages), to transfer only safe messages back to the target computing device 21 of secured network 20, according to rule-base data structure 135A, as elaborated herein. For example, filter module 135 may be configured to only allow secondary channel data element 151 that are synchronization messages or keep alive messages to be transferred, if they comply with respective rules dictated by rule-base data structure 135A, as elaborated herein.

Additionally, or alternatively, the received one or more secondary channel data elements 151 may originate from at least one first computing device 31 in unsecured network 30, and the received one or more secondary channel data elements 151 may include, for example a command or notification for operating or configuring at least one second computing device 21 in the secured network 20.

For example, the at least one first computing device 31 may be a user's laptop, a management console a computer terminal and the like, and the at least one second computing device 21 may be an IoT device such as a closed circuit camera that is adapted to be remotely-controlled. In this example, the one or more secondary channel data elements 151 may include for example, a data packet that includes a command to turn the camera on or off, zoom in or out, rotate clockwise or counter-clockwise, and the like. In such embodiments, secondary channel filter module 135 may be adapted to analyze the secondary channel data elements 151 (e.g., configuration or notification messages), to transfer only safe or harmless configuration messages back to the target computing device 21 of secured network 20, according to rule-base data structure 135A, as elaborated herein. Pertaining to the example of the camera, rule-base data structure 135A may include a plurality of rules, each defining limits or constraints for safe or required operation of the camera. Such rules may include for example, (a) a limit for the number of configuration messages that the camera may receive at a given timeslot and/or one or more concurrent time slots, (b) a limit to one or more parameters (e.g., rotation, refresh rate, image brightness, field of view, etc.), and/or (c) allowance or prevention of setting an operation mode or state (e.g., on/off/standby). Thus, secondary channel filter module 135 may enforce the rules, as dictated by rule-base data structure 135A, so as to prevent a user of computing device 31 (in unsecured network 30) from tampering with, or hacking computing devices 21 (e.g., the camera).

According to some embodiments of the invention, secondary channel filter module 135 may receive at least one data element that is a rule-base data structure 135A. According to some embodiments, secondary channel filter module 135 may completely filter out or discard the received secondary channel data elements 151, or transfer only a portion or subset of the received secondary channel data elements 151 to a target computing device 21 in secured network 20 according to content of rule-base data structure 135A, as elaborated herein.

According to some embodiments, filter module 135 may analyze and indicate (e.g., via indicator 42) information pertaining to the number of secondary channel data elements 151 that were transferred and/or discarded. Additionally, filter module 135 may indicate (e.g., via indicator 42) information pertaining to a cause for the discarding of data elements, e.g., due to a specific rule or condition of rule-base data structure 135A.

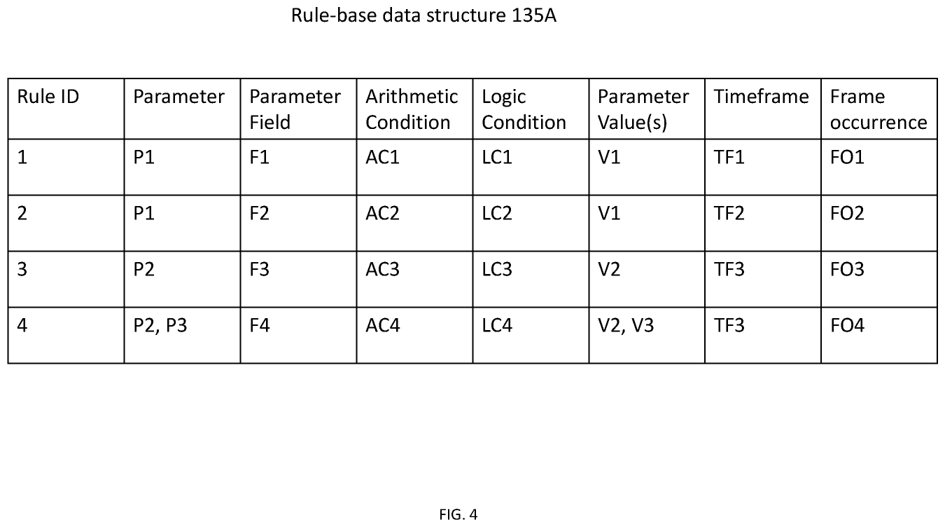

Reference is now made to FIG. 4 which is a schematic diagram, depicting an example secondary channel rule-base data structure 135A, that may be included in system 100 for isolating data flow between secured network 20 and an unsecured network 30, according to some embodiments of the invention. Other structures may be used.

As shown in the example of FIG. 4, rule-base data structure 135A may be or may include a data structure such as a table, where each entry (e.g., row) in the table corresponds to a specific rule. These rules are denoted in FIG. 4 as rule IDs 1-4.

According to some embodiments of the invention, rule-base data structure 135A may include at least one definition of a parameter and zero, one or more conditions that correspond to the parameter. For example, as shown in the example of FIG. 4, parameter P1 may correspond to arithmetic condition AC1 and/or to logic condition LC1.

Filter module 135 may be configured to filter secondary channel data elements 151, so as to transfer a portion or subset of secondary channel data elements 151 to a computing device 21 in secured network via second communication channel 300 according to the zero or more defined parameters (e.g., P1) and corresponding zero, one or more conditions (e.g., AC1, LC1).

In other words, filter module 135 be configured to filter secondary channel data elements 151 and allow only a subset of the received secondary channel data elements to pass to secured network 20, via the second communication channel 300, based on the one or more rules of rule-base data structure 135A.

Pertaining to the example where computing device 31 is a user's laptop, and computing device 21 is a remote-controllable camera; Parameter P1 may be a yaw angle, and arithmetic condition AC1 may include an arithmetic statement that P1 should not exceed a specific yaw angle parameter value, denoted in FIG. 4 as V1. In other words, AC1 may be “P1=<V1”.

In this condition, filter module 135 may filter out or remove a secondary channel data element 151 (e.g., a data packet) that includes a command or configuration of P1 that exceeds the limit of V1. In other words, filter module 135 may transfer to computing device 21 only secondary channel data elements 151 that comply with rules of rule-base data structure 135A (e.g., in this example: configuration commands that do not exceed the V1 limit).

According to some embodiments of the invention, rule-based data structure 135A may include one or more rule entries that may relate to more than one parameter and or be a logical composite of two or more logical sentences or conditions. For example rule ID 4 may be a logical condition that combines two or more conditions on at least one parameter (e.g., P2 and P3). For example, rule ID 4 may be or may include a condition such as ((P2>V2) OR (P3=V3)). In another example, rule ID 4 may be or may include a condition such as ((P2>V2) AND (P2<V3)). Pertaining to the example of the closed circuit camera, P2 may be an elevation angle, and the logical sentence ((P2>V2) AND (P2<V3)) may dictate a rule, that limits an allowable elevation angle to between the values of V2 and V3.

According to some embodiments, secondary channel data element 151 may be formatted as a data frame or data packet, and may include payload data within the data frame or data packet, as known in the art. For example, payload data may include information that is devoid of at least some of the metadata (e.g., packet size, source address, destination address, etc.) that may pertain to the data frame of secondary channel data element 151. Filter module 135 may receive a first secondary channel data element 151 that includes payload data in a first version, and filter the secondary channel data element 151 by: (a) changing the payload data to a second version; and (b) transferring the secondary channel data element, with the payload data of the second version, to secured network 20, via secondary communication channel 300.

Pertaining to the same example of a camera, where parameter P1 may be a yaw angle, and arithmetic condition AC1 may include an arithmetic statement that P1 should not exceed a specific yaw angle parameter value (e.g., “P1=<V1”); Consider a condition, in which filter module 135 may receive a first secondary channel data element 151 that includes a payload data element that is a command to change P1 (e.g., the yaw parameter) by 80 degrees, whereas the limit value, V1 is 50 degrees. In this condition, filter module 135 may change the payload data to a second version (e.g., from 80 degrees to 50 degrees), and transfer the secondary channel data element, with the payload data of the second version (e.g., 50 degrees), to secured network 20, via secondary communication channel 300.

According to some embodiments of the invention, rule-base data structure 135A may include one or more rule or definition entries that pertain to parameter fields (e.g., F1-F4), and filter module 135 may be configured to transfer secondary channel data element 151 if they comply with said rules of parameter fields. In other words, rule-base data structure 135A may include at least one definition of a parameter field (e.g., F1-F4), and zero, one or more conditions (e.g., AC1, LC1, AC2, LC2, etc.) corresponding to the at least one parameter field. Filter module 135 may be adapted to filter the one or more secondary channel data elements 151 according to the at least one defined parameter field and corresponding zero or more conditions.

For example, parameter field F1 may point or refer to a specific field or location in a payload of a secondary channel data element 151. Additionally, or alternatively, a parameter (e.g., P1) may be a composite parameter, such as a vector of elements (e.g., a roll parameter, a pitch parameter and a yaw parameter of a camera), and a parameter field F1 may point, or refer to a specific section or index of composite parameter P1 (e.g., to the pitch parameter). In such conditions, filter module 135 may be configured to transfer the secondary channel data element 151, with the payload of parameter P1 and parameter field F1 via secondary communication channel 300, only if parameter P1 and/or parameter field F1 comply with the relevant rule. Pertaining to the same example of a camera, if parameter field F1 is a pitch angle, and arithmetic condition AC1 includes an arithmetic statement that F1 should not exceed a specific value V1, then filter module 135 may be configured to transfer a secondary channel data element 151 that includes pitch angle payload only if the condition (F1=<V1) is fulfilled.

According to some embodiments of the invention, rule-base data structure 135A may include one or more rule or definition entries that pertain to time frames, and a corresponding definition of a number of occurrences. Filter module 135 may be adapted to filter the one or more secondary channel data elements 151 such that the number of transferred secondary channel data elements does not surpass the defined number of occurrences within the defined time frame. Pertaining to the example of the closed circuit camera, rule ID 1 may dictate that within a timeframe of TF1 (e.g., an hour), only a predefined integer number of FO1 (e.g., 1, 2, etc.) occurrences for configuration of parameter P1 (e.g., a yaw angle) may be transferred via secondary channel 300 to a computing device 21 (e.g., the camera) in secured network 20. Filter module 135 may be configured to act upon rules of rule-base data structure 135A and filter secondary channel data elements 151, so as to transfer only the predefined number of configuration messages computing device 21. In this example, filter module 135 be configured to only pass FO1 configuration messages of parameter P1 to computing device 21, via secondary channel 300, with a time period of TF1 (e.g., an hour).

Additionally, filter module 135 be configured act upon concurrent time frame rules that are a logical composite of conditions or logical sentences. For example, filter module 135 be configured to transfer a first number of secondary channel data elements 151 over a first predefined time frame, and transfer a second number of secondary channel data elements 151 over a second predefined time frame. Pertaining to the example of FIG. 4, filter module 135 be configured to transfer only F01 secondary channel data elements 151 (e.g., configuration messages of parameter P1) over the TF1 time frame (e.g., minute), AND transfer only F02 secondary channel data elements 151 over a concurrent TF2 time frame (e.g., hour).

According to some embodiments of the invention, system 100 may collaborate with at least one trusted computing device in secured network 20, to dynamically configure rule-base data structure 135A.

For example, secondary channel filter module 135 may be communicatively connected, e.g., by wired connection, via a dedicated port such as control channel port 137 of FIG. 1, to a trusted computing device 21C, in secured network 20. Secondary channel filter module 135 may dynamically receive from trusted computing device 21C a configuration signal or message 62, to configure (e.g., write, edit, delete, etc.) one or more elements or entries in rule-base data structure 135A, and may dynamically change rule-base data structure 135A according to the received message 62. The term “dynamic” may be used in this context in a sense that the configuration or change of data structure 135A may be based on real-world events, such as reception of a configuration signal or message 62 from an administrative user and/or a trusted computing device 21C.

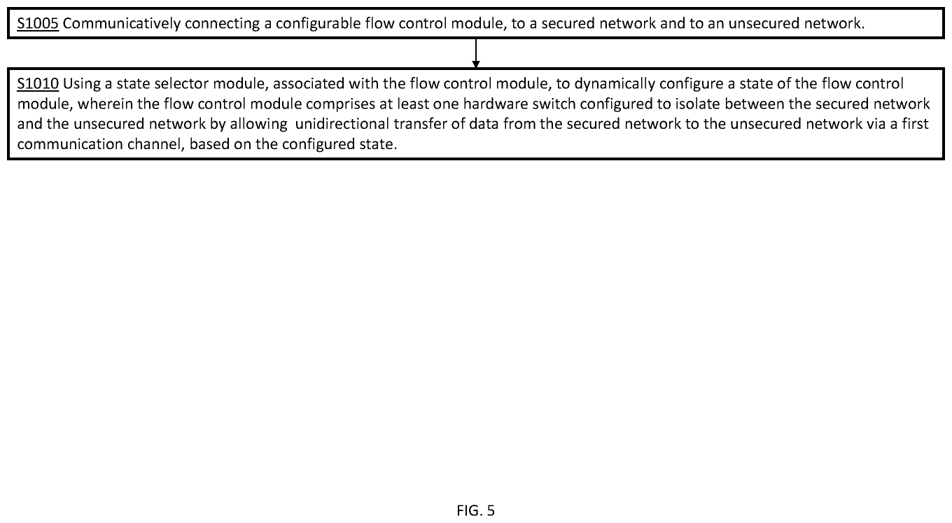

Reference is now made to FIG. 5 which is a flow diagram, depicting a method of securing network connectivity, according to some embodiments of the invention.

As shown in step S1005, embodiments of the method may include communicatively connecting a configurable flow control module (e.g., flow control module 110 of FIG. 1), to one or more computing devices (e.g., elements 21 of FIG. 1) of the secured network (e.g., secured network 20 of FIG. 1) to one or more computing devices (e.g., elements 31 of FIG. 1) of the unsecured network (e.g., unsecured network 30 of FIG. 1).

As shown in step S1010, embodiments of the method may include using a state selector module (e.g., state selector module 140 of FIG. 1), associated with the flow control module, to dynamically configure a state of flow control module 110. As elaborated herein, flow control module 110 may include at least one hardware switch (e.g., hardware switch 111 of FIG. 1), configured to isolate secured network from unsecured network, by allowing unidirectional transfer of data from secured network 20 to unsecured network 30 (e.g., disabling transfer of data from unsecured network 30 to secured network 20) via a first communication channel (e.g., element 200 of FIG. 1), based on the configured state, as elaborated herein.

Embodiments of the invention include a practical application for securing computer communication. Embodiments of the invention include several improvements over currently available systems for securing computer network connectivity, such as “data diodes” as known in the art.

For example, embodiments of the invention include complete electronic isolation of a secured network from an unsecured network, while facilitate unidirectional transmission of data between these networks via a first communication channel (e.g., primary channel 200). As elaborated herein, the isolation of the secured network from the unsecured network may be completely hardware-based, and may thus not be susceptible to software-based tampering.

Additionally, embodiments of the invention include secure, dynamic configuration of directionality of data flow between the secured network and the unsecured network via the first communication channel. This is in contrast to currently available systems (e.g., “data diodes”) that only allow unidirectional flow of data, without facilitating secure transfer of data in the opposite direction on the primary communication channel. Such transfer of data in the opposite direction (e.g., from the unsecured network to the secured network) on the primary communication channel 200 may enable embodiments of the invention to facilitate a plurality of scenarios where such transactions are required, in a controlled and secured manner.

Such The term “secure” may be used in this context to indicate that the module controlling the direction may be completely disconnected from the first communication channel, and may be devoid of a communication address and/or a processing unit. For example, embodiments of the invention may allow the direction of unidirectional data transfer to be dynamically set by a secure event, such as a press of a button in a secure location, or upon reception of a control signal from a secure computing device, as elaborated herein.

Additionally, embodiments of the invention may include a secondary communication channel that may complement the unidirectional communication of data in over the first data channel, facilitating connection-oriented and/or connectionless communication in a secure, and monitored manner.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system for isolating data flow between a secured network and an unsecured network, the system comprising:
a flow control module, connected to the secured network and to the unsecured network; and
a state selector module, associated with the flow control module and adapted to dynamically configure a state of the flow control module,
wherein the flow control module comprises at least one hardware switch configured to isolate the secured network from the unsecured network by allowing unidirectional transfer of data from the secured network to the unsecured network via a first communication channel, based on the configured state.

2. The system of claim 1, wherein the flow control module does not comprise a processing unit, and wherein the flow control module is not associated with an Internet protocol (IP) address, and wherein the flow control module is not associated with a media access control (MAC) address.

3. The system of claim 1, wherein the hardware switch is implemented by one or more transistors on an electronic device selected from a list consisting of: a programmable array logic (PAL) device, a simple programmable logic device (SPLD), a complex programmable logic device (CPLD), a field programmable gate array (FPGA) device, and an application specific integrated circuit (ASIC) device.

4. The system of claim 1, wherein said state of the flow control module is selected from a list consisting of: a unidirectional, secure-to-unsecure (S2U) state, a unidirectional, unsecure-to-secure (U2S) state, a bidirectional state and a disconnected state.

5. The system of claim 4, wherein in the S2U state, the flow control module is configured to allow unidirectional transfer of data from the secured network to the unsecured network via the first communication channel, and disallow transfer of data from the unsecured network to the secured network.

6. The system of claim 4, wherein in the U2S state, the flow control module is configured to allow unidirectional transfer of data from the unsecured network to the secured network via the first communication channel, and disallow transfer of data from the secured network to the unsecured network.

7. The system of claim 6 wherein the flow control module is configured to be in the U2S state for a configurable period of time or until a predefined event occurs, after which the flow control module is configured to switch to the S2U state.

8. The system of claim 4, wherein in the bidirectional state, the flow control module is configured to allow transfer of data from the secured network to the unsecured network via the first communication channel, and allow transfer of data from the unsecured network to the secured network via the first communication channel.

9. The system of claim 7 wherein the flow control module is configured to be in the bidirectional state for a configurable period of time or until a predefined event occurs, after which the flow control module is configured to switch to the S2U state

10. The system of claim 4, wherein in the disconnected state, the flow control module is configured to disallow transfer of data from the secured network to the unsecured network via the first communication channel, and disallow transfer of data from the unsecured network to the secured network via the first communication channel.

11. The system of claim 4, further comprising a first protocol termination module, and wherein in the S2U state, the first protocol termination module is adapted to:
receive at least one connection-oriented data element from at least one first computing device of the secured network;
transmit an acknowledgement data element, corresponding to the at least one connection-oriented data element to the at least one first computing device; and
transmit the at least one connection-oriented data element to at least one second computing device of the unsecured network.

12. The system of claim 4, further comprising a second protocol termination module, and wherein in the U2S state, the second protocol termination module is adapted to:
receive at least one connection-oriented data element from at least one first computing device of the unsecured network;
transmit an acknowledgement data element, corresponding to the at least one connection-oriented data element, to the at least one first computing device; and
transmit zero or more connection-oriented data elements, to the secured network, via a second communication channel.

13. The system of claim 1, further comprising a filter module, adapted to:
receive one or more secondary channel data elements from at least one of: (a) the second protocol termination module and (b) a computing device in the unsecured network; and
filter the one or more secondary channel data elements; and
transfer zero or more filtered secondary channel data elements, to a computing device in the secured network, via a second communication channel.

14. The system of claim 13, wherein the filter module is further adapted to:
receive a rule-base data structure; and
filter the one or more secondary channel data elements according to the rule-base data structure.

15. The system of claim 14, wherein the filter module is communicatively connected to a trusted computing device in the secured network 20, and wherein the filter module is adapted to:
dynamically receive, from the trusted computing device, a configuration signal or message; and
configure the rule-base data structure according to the received configuration message.

16. The system of claim 13, wherein filtering the one or more secondary channel data elements comprises allowing only a subset of the received secondary channel data elements to pass to the secured network, via the second communication channel.

17. The system of claim 13, wherein at least one received secondary channel data element comprises payload data in a first version, and wherein filtering the secondary channel data element comprises:
changing the payload data to a second version; and
transferring the secondary channel data element, with the payload data of the second version to the secured network, via the second communication channel.

18. The system of claim 13, wherein the received one or more secondary channel data elements originate from the second protocol termination module, and wherein the received one or more secondary channel data elements are selected from list consisting of: synchronization data, keep-alive packets and acknowledgment messages.

19. The system of claim 13, wherein the received one or more secondary channel data elements originate from at least one first computing device in the unsecured network, and wherein the received one or more secondary channel data elements comprise a command for operating at least one second computing device in the secured network.

20. The system of claim 14, wherein the rule-base data structure comprises at least one definition of a parameter and zero, one or more conditions corresponding to the at least one parameter, and wherein the filter module is adapted to filter the one or more secondary channel data elements according to the at least one defined parameter and corresponding zero or more conditions.

21. The system of claim 14, wherein the one or more conditions are arithmetic conditions, and wherein the filter module is adapted to filter the one or more secondary channel data elements according to the one or more arithmetic conditions.

22. The system of claim 21, wherein the one or more conditions are logical conditions, and wherein the filter module is adapted to filter the one or more secondary channel data elements according to the one or more logical conditions.

23. The system of claim 14 wherein the rule-base data structure comprises at least one definition of a parameter field, and zero, one or more conditions corresponding to the at least one parameter field, and wherein the filter module is adapted to filter the one or more secondary channel data elements according to the at least one defined parameter field and corresponding zero or more conditions.

24. The system of claim 14, wherein the rule-base data structure comprises at least one definition of a time frame and a corresponding definition of a number of occurrences, and wherein the filter module is adapted to filter the one or more secondary channel data elements such that the number of transferred secondary channel data elements does not surpass the defined number of occurrences within the defined time frame.

25. The system of claim 13 wherein the second communication channel has a smaller transmission bandwidth in relation to a transmission bandwidth of the first communication channel.

26. The system of claim 1, wherein the state selector module is adapted to dynamically configure the state of the flow control module by:
receiving a control signal from a trusted computing device of the secured network; and
configuring the state of the flow control module according to the received control signal.

27. A method of isolating data flow between a secured network and an unsecured network, the method comprising: using a state selector module, to dynamically configure a state of a flow control module, wherein the flow control module is connected to the secured network and to the unsecured network; and wherein the flow control module comprises at least one hardware switch; and wherein the at least one hardware switch is configured to allow unidirectional transfer of data between the secured network and the unsecured network via a first communication channel, based on the configured state.
